(19) United States
(12) Patent Application Publication
(10) Pub. No.: US 2014/0049846 A1
(43) Pub. Date: Feb. 20, 2014

(54) MULTILAYER LENS ASSEMBLY AND THE METHOD OF MAKING THE SAME

(71) Applicant: Wu-Li WANG, Tainan City (TW)

(72) Inventor: Wu-Li WANG, Tainan City (TW)

(21) Appl. No.: 13/587,432

(22) Filed: Aug. 16, 2012

(51) Int. Cl. G02B 11/02; B29D 11/00

(52) U.S. Cl. 359/793; 264/1.7

(57) ABSTRACT

A multilayer lens assembly includes a first lens, a spacer, and a second lens stacked in sequence. The first lens, the second lens and spacer are made of photo-curing materials. The transmittances of the first lens and the second lens are greater than 95% and refractive indexes thereof are greater than 1. The transmittance of the spacer is greater than 95% and the refractive index thereof is greater than 1. The refractive index of the spacer is not identical to the refractive indexes of the first lens and the second lens. Opposite sides of the spacer are respectively affixed to the first lens and the second lens.

### BACKGROUND OF THE INVENTION

1. Field of the Invention

The present invention relates generally to an optical lens, and more particularly to a multilayer lens assembly and the method of making the same.

2. Description of the Related Art

With advancement in technology, image capture devices, such as charge coupled device (CCD) or complementary metal oxide semiconductor (CMOS) are widely used in image pick-up apparatus, such as digital camera and cell phone. In recent days, the image pick-up apparatus is made as smaller as possible, so that the image capture devices have to reduce its size accordingly. The pixel of the image capture device is increasing, and therefore the lens must have high optical performance to reach the high resolution and contrast. Consequently, small size and high optical performance are the important facts of modern lenses.

As shown in FIG. 1, a multilayer lens assembly 2 of a conventional lens module has a first lens 60 and a second lens 62 stacked on the first lens 60. Between the first and the second lenses 60 and 62 is nothing but air.

It makes a miniature lens module by the stacked lenses 60 and 62. However, air is the medium between the lenses 60 and 62 for the light emitting through. The refractive index difference between the lens and air is large enough to cause a sufficient shift of light when the light emits through the first lens 60, air, and second lens 62 in sequence. The shift of light reduces the transmittance of the conventional multilayer lens assembly 2. One option to overcome this problem is to lengthen a distance between the lenses 60 and 62. However, it enlarges the thickness of the multilayer lens assembly 2.

### SUMMARY OF THE INVENTION

The primary objective of the present invention is to provide a multilayer lens assembly, which has a high transmittance and small thickness.

According to the objective of the present invention, a multilayer lens assembly includes a first lens, a spacer, and a second lens stacked in sequence. The first lens is made of a photo-curing material, and it has a transmittance greater than 95% and a refractive index greater than 1. The second lens is made of a photo-curing material, and it has a transmittance greater than 95% and a refractive index greater than 1. The spacer is made of a photo-curing material, and it has a transmittance greater than 95% and a refractive index greater than 1. The refractive index of the spacer is not identical to the refractive indexes of the first lens and the second lens. The spacer has opposite affixed to the first lens and the second lens.

In an embodiment, the refractive indexes of the first lens, the second lens, and the spacer are in a range between 1.2 and 2.0.

In an embodiment, the first lens, the second lens, and the spacer are made of UV-curing epoxy.

In an embodiment, a difference between the refractive indexes of the first lens and the second lens and the refractive index of the spacer is less than 0.5.

In an embodiment, the multilayer lens assembly further includes an infrared ray filter between the first lens and the spacer.

In an embodiment, the multilayer lens assembly further includes an infrared ray filter on the first lens.

In an embodiment, the multilayer lens assembly further includes an infrared ray filter between the second lens and the spacer.

In an embodiment, the multilayer lens assembly further includes an infrared ray filter on the second lens.

In an embodiment, the multilayer lens assembly further includes a support member on a side of the second lens opposite to the spacer, wherein the support member has a bore to expose at least a portion of the second lens.

In an embodiment, a thickness of the spacer is greater than 1 μm.

A method of making multilayer lens assemblies includes the following steps:

A. Provide a molten lens material on a base mold and pressing a top mold on the lens material to obtain a first lens layer after the lens material is solidified, and then remove the top mold;

B. Provide a molten spacer material on the first lens layer and pressing a top mold on the spacer material to obtain a spacer layer after the spacer material is solidified, and then remove the top mold;

C. Provide a molten lens material on the spacer layer and pressing a top mold on the lens material to obtain a second lens layer after the second lens material is solidified, and then remove the top mold;

D. Remove the base mold to obtain a lens assembly block; and

E. Cut the lens assembly block to obtain a plurality of multilayer lens assembly.

In an embodiment, the method further includes the step of repeating the step B and the step C for predetermined times before the step D.

In an embodiment, the lens materials are photo-curing materials, and the lens materials are respectively exposed under a predetermined light for curing in the step A and the step C.

In an embodiment, the lens materials are UV-curing epoxy, and the lens materials are exposed under UV light for curing in the step A and the step C.

In an embodiment, the top molds used in the step A and the step C are transparent.

In an embodiment, the spacer material is a photo-curing material, and the spacer material is exposed under a predetermined light for curing in the step B.

In an embodiment, the spacer material is UV-curing epoxy, and the spacer material is exposed under UV light for curing in the step B.

In an embodiment, the top mold used in the step B is transparent.

In an embodiment, transmittances of the first lens layer, the second lens layer, and the spacer layer are greater than 95%.

In an embodiment, refractive indexes of the first lens layer, the second lens layer and the spacer layer are greater than 1, and the refractive index of the spacer layer is not identical to the refractive indexes of the first lens layer and the second lens layer.

In an embodiment, a difference between the refractive indexes of the first lens and the second lens and the refractive index of the spacer is less than 0.5.

In an embodiment, the refractive indexes of the first lens, the second lens, and the spacer are in a range between 1.2 and 2.0.

In an embodiment, the method further includes the step of providing an infrared ray filter on the first lens layer before the step B.

In an embodiment, the method further includes the step of providing an infrared ray filter on the spacer layer before the step C.

In an embodiment, the method further includes the step of providing an infrared ray filter on the first lens layer or the second lens layer before the step E.

In an embodiment, the method further includes the step of providing a support layer on the second lens layer, and then removing predetermined portions of the support layer before the step D, wherein the remaining portions of the support layer are cut in the step E.

In an embodiment, the method further includes the steps of providing a molten mold material on a substrate; pressing a top mold on the mold material for curing; and removing the top mold and the substrate to obtain the base mold before the step A.

In an embodiment, the method further includes a thickness of the spacer is greater than 1 μm.

Therefore, the multilayer lens assembly has a small shift when light emits through to obtain a high transmittance and a low thickness.

### BRIEF DESCRIPTION OF THE DRAWINGS

FIG. 1 is a sectional view of the conventional multilayer lens assembly;

FIG. 2 to FIG. 11 are sectional views of a preferred embodiment of the present invention, showing the procedures of making the multilayer lens assembly;

FIG. 12 is a sectional view of the multilayer lens assembly of the preferred embodiment of the present invention; and

FIG. 13 and FIG. 14 are sectional view of the preferred embodiment of the present invention, showing the procedures of making the base mold.

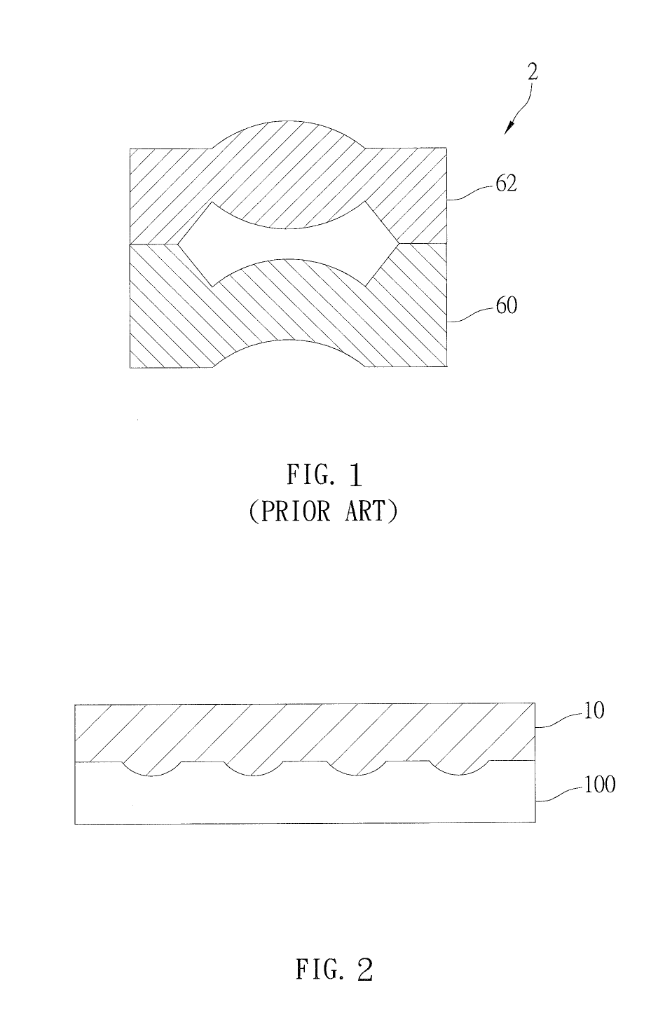

### DETAILED DESCRIPTION OF THE INVENTION

The detailed description and technical contents of the present invention will be explained with reference to the accompanying drawings. However, the drawings are illustrative only but not used to limit the present invention.

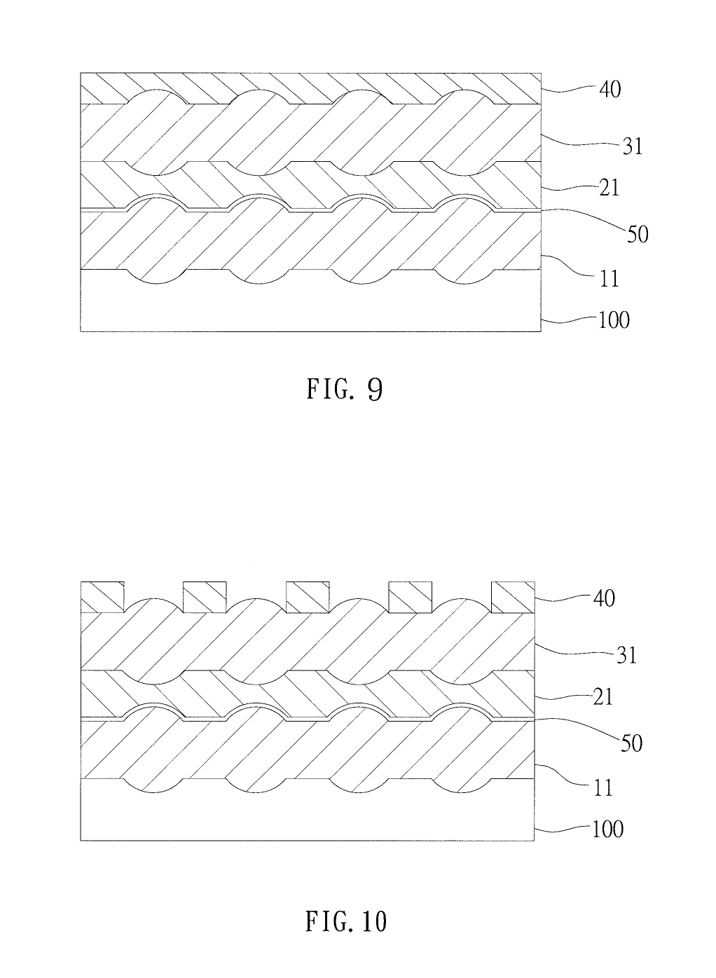

As shown in FIG. 2 to FIG. 11, a method of making a multilayer lens assembly 1 of the preferred embodiment of the present invention includes the following steps:

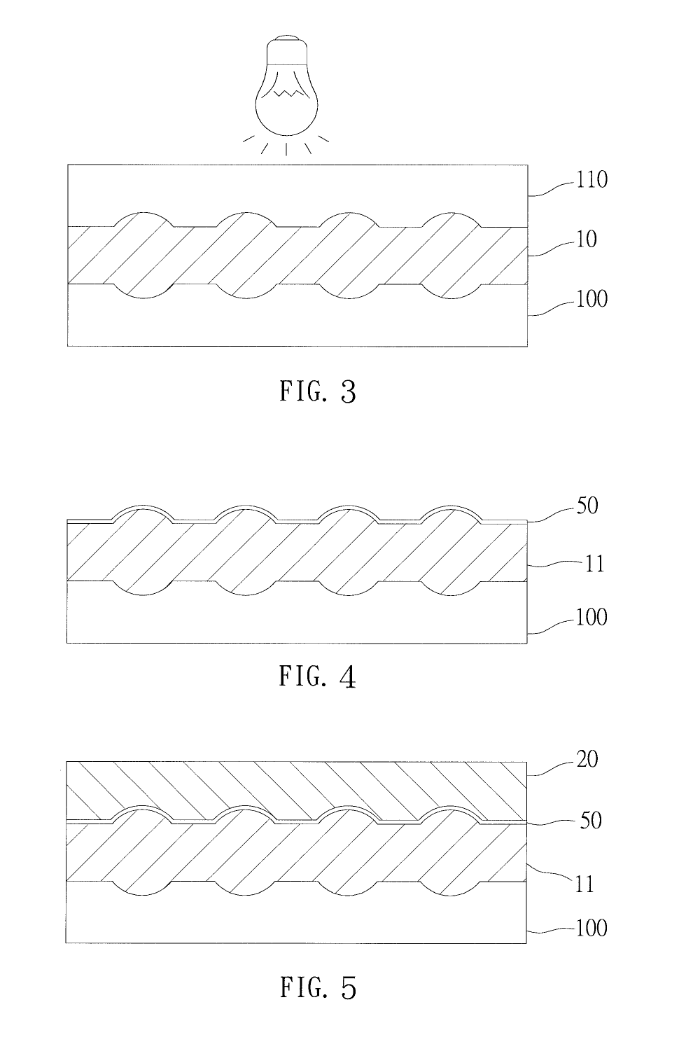

A. Pour a molten lens material 10 on a base mold 100 (FIG. 2). In an embodiment, the lens material 10 is UV-curing epoxy, and a transmittance of the solidified lens material 10 is greater than 95% and a refractive index thereof is between 1.2 and 2.0. Place a transparent top mold 110 on the base mold 100 to press the molten lens material 10, and then expose the lens material 10 under UV light for curing. After the lens material 10 solidified, remove the top mold 110 to obtain a first lens layer 11 (FIG. 3). The first lens layer 11 has alternate lens portions and connection portions.

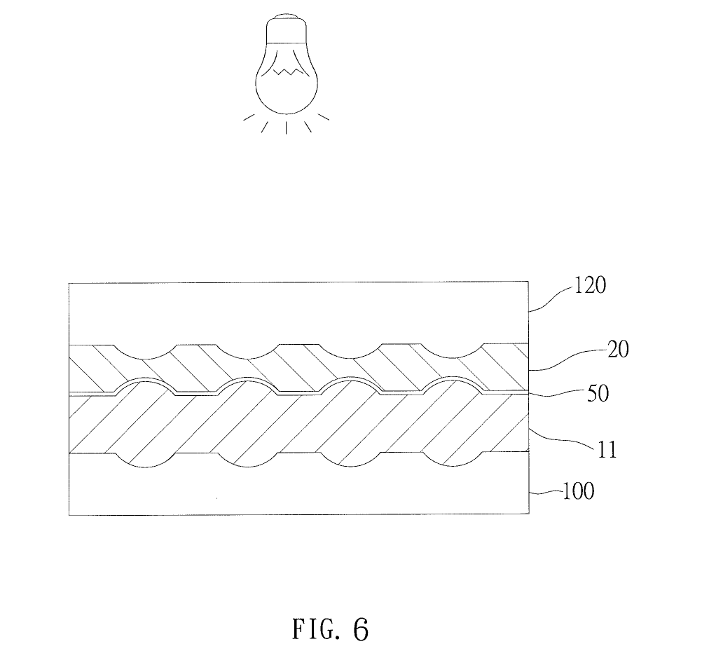

B. Coat an IR (infrared ray) filter 50 on the first lens layer 11 (FIG. 4), and then pour a molten spacer material 20 on the first lens layer 11 (FIG. 5). In an embodiment, the spacer material 20 is UV-curing epoxy as well. A refractive index of the solidified space material 20 is not identical to the refractive index of the lens material 10, and a difference between the refractive indexes of the solidified lens material 10 and the space material 20 is less than 0.5. Place a transparent top mold 120 on the base mold 100 to press the molten spacer material 20, and then expose the spacer material 20 under UV light. After the spacer material 10 solidified, remove the top mold 120 to obtain a spacer layer 21 affixed to the first lens layer 11 (FIG. 6).

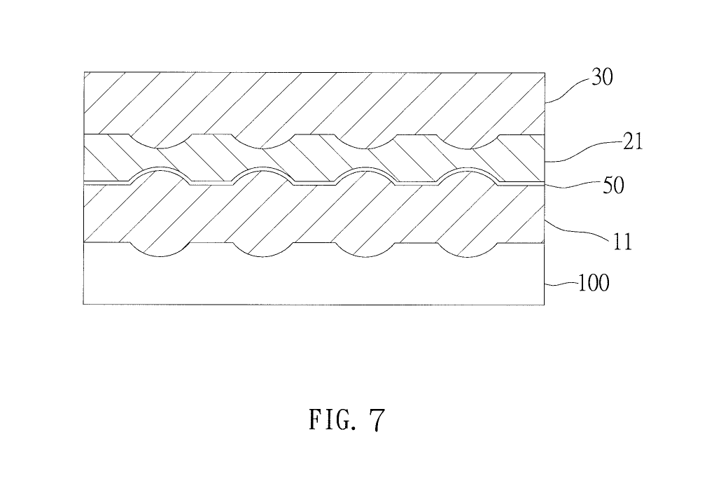

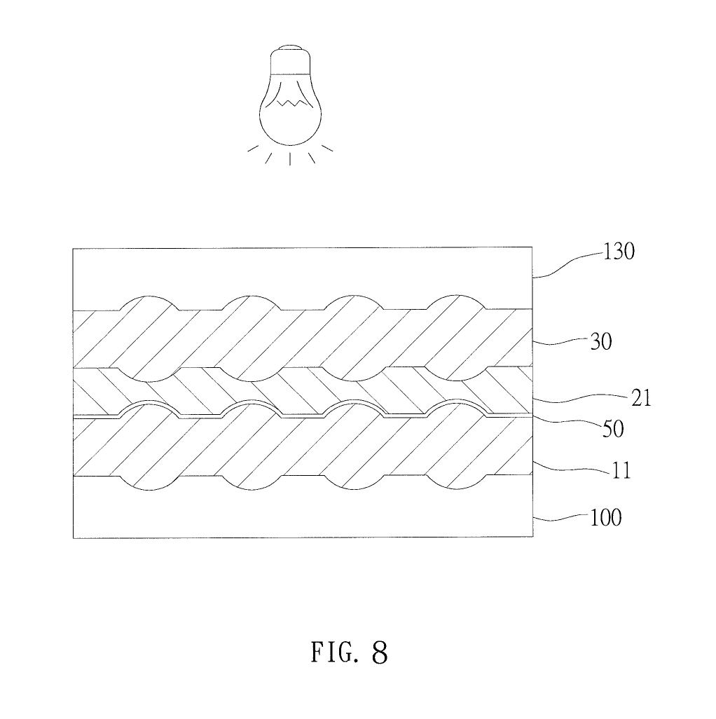

C. Pour a molten lens material 30, which is the same as the lens material 10, on the spacer layer 21 (FIG. 7), and then place a transparent top mold 130 on the base mold 100 to press the molten lens material 30. The lens material 30 is solidified by exposing the lens material 30 under UV light to obtain a second lens layer 31 affixed to the spacer layer 21 (FIG. 8). The second lens layer 31 has alternate lens portions and connection portions.

D. Coat a support layer 40 on the second lens layer 31 and expose the lens portions of the second lens layer 31 by etching (FIG. 10). Next, remove the base mold 100 to obtain a lens assembly block 200. The lens assembly block 200 includes the first lens layer 11, the spacer layer 21, the second lens layer 31, and the support layer 40 stacked in sequence. The support layer 40 covers the connection portions of the second lens layer 31.

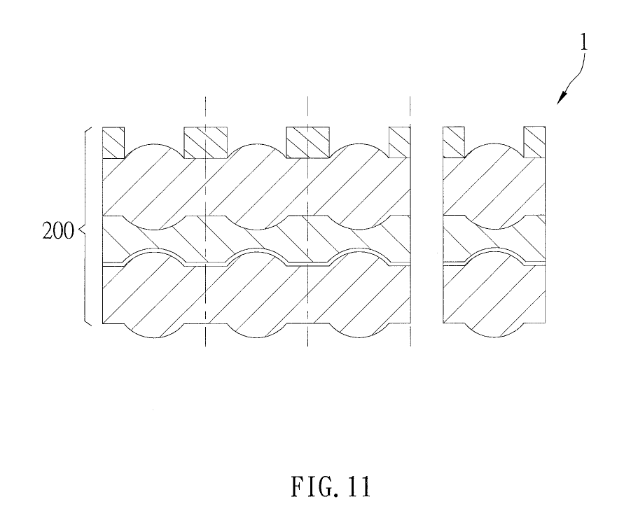

E. Cut the lens assembly block 200 to obtain a plurality of multilayer lens assemblies 1 (FIG. 11). A cutter (not shows) cuts the remaining portions of the support layer 40, and therefore it will cut the connection portions of the first and the second lens layer 11, 31, and of course, it cuts the spacer layer 21 as well.

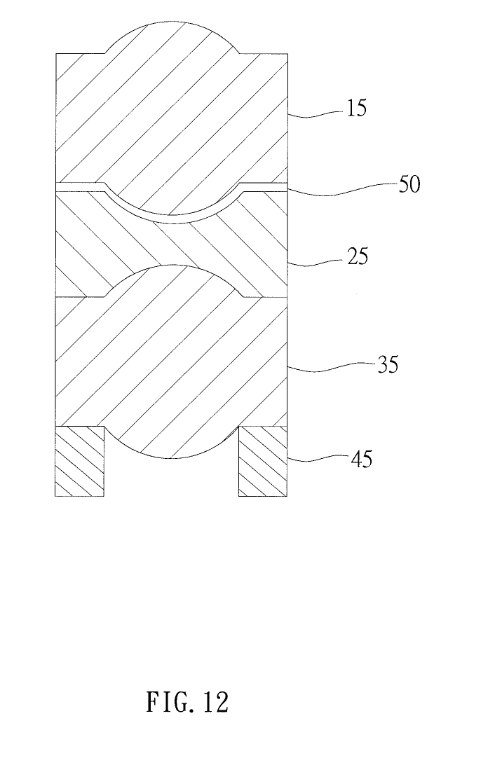

As shown in FIG. 12, each multilayer lens assembly 1 has a first lens 15 (formed by the first lens layer 11), a spacer 25 (formed by the spacer layer 21), a second lens 35 (formed by the second lens layer 31), and a support member 45 (formed by the support layer 40) stacked in sequence, and the IR filter 50 is between the first lens 15 and the spacer 25.

A thickness of the spacer 25 is greater than 1 μm to change the light's optical character when light emits through it. The support member 45 has a bore to expose a lens portion of the second lens 35. The support member 45 has the support function, and it may adjust the path of light. The IR filter 50 may filter the unnecessary infrared ray out to increase the optical performance of the multilayer lens assembly 1 of the present invention.

The present invention provides a low difference of the refractive indexes of the lenses 15, 35 and the spacer 25. The difference of the refractive indexes is less than 0.5 in an embodiment to reduce the light shift when light emits through the multilayer lens assembly 1 of the present invention and increase the transmittance thereof. It overcomes the problems of the conventional lens assembly to achieve both purposes of miniaturization and low light shift.

In an embodiment, the refractive indexes of the first lens 15 and the second lens 35 are the same, and are different from the refractive index of the spacer 25. In order to obtain a specified optical performance of the multilayer lens assembly 1 it may choose specified lens materials and the spacer material to form the lenses and the spacer with predetermined refractive indexes, such as the refractive indexes of the first lens 15 and the second lens 35 are different.

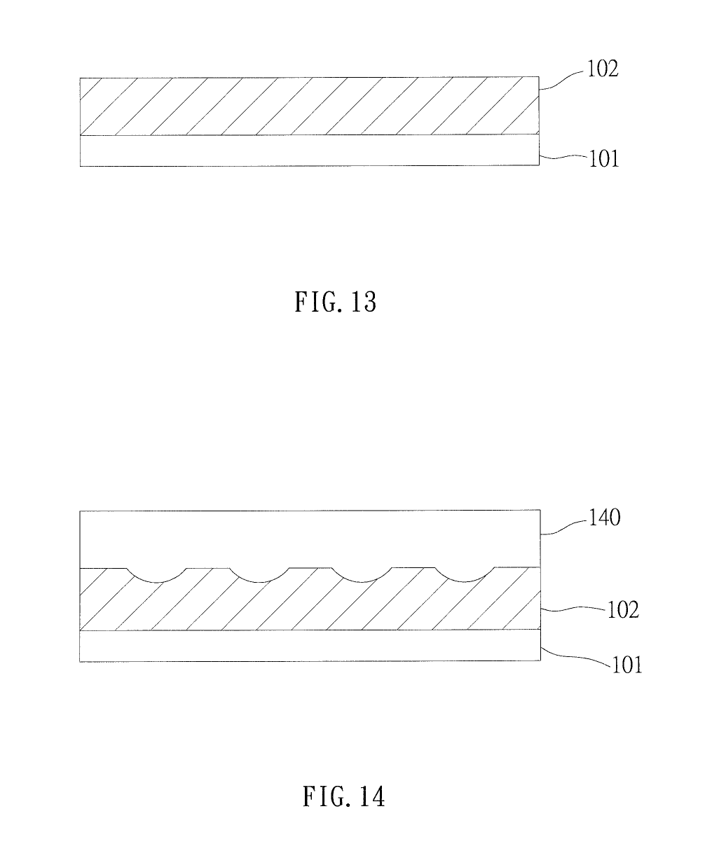

FIG. 13 and FIG. 14 shows the steps of making the base mold 100, including pouring a molten mold material 102 on a substrate 101 (FIG. 13); pressing a mold member 140 on the molten mold material 102 for curing (FIG. 14); and remove the mold member 140 and the substrate 101 to obtain the base mold 100. The base mold 100 must have a precise cavity to form the first lenses therefore it may simply replace the damaged base mold 100 with a new one.

The IR filter 50 may be coated on the spacer layer 21 or on the second lens layer 31 except for being coated on the first lens later 11. In an embodiment, the multilayer lens assembly has no IR filter.

The base mold 100 and the top molds 110-130 may have different cavities to form the specified lenses 15, 35 according to the design, such as biconvex lens, biconcave lens, positive meniscus lens, negative meniscus lens, plano-convex lens, and plano-concave lens.

In an embodiment, it may make a multilayer lens assembly having three or more lenses as long as the operator repeats the step B and the step C until the desired number of the lenses is reached. Besides, the lens material 10, 30 and the spacer material 20 may use any photo-curing material with refractive index greater than 1. The description above is a few preferred embodiments of the present invention and the equivalence of the present invention is still in the scope of claim construction of the present invention.

What is claimed is:

1. A multilayer lens assembly, comprising:
a first lens, which is made of a photo-curing material, having a transmittance greater than 95% and a refractive index greater than 1;
a second lens, which is made of a photo-curing material, having a transmittance greater than 95% and a refractive index greater than 1; and
a spacer, which is made of a photo-curing material, having a transmittance greater than 95% and a refractive index greater than 1;
wherein the refractive index of the spacer is not identical to the refractive indexes of the first lens and the second lens, and opposite sides of the spacer are respectively affixed to the first lens and the second lens.

2. The multilayer lens assembly as defined in claim 1, wherein the refractive indexes of the first lens, the second lens, and the spacer are in a range between 1.2 and 2.0.

3. The multilayer lens assembly as defined in claim 1, wherein the first lens, the second lens, and the spacer are made of UV-curing epoxy.

4. The multilayer lens assembly as defined in claim 1, wherein a difference between the refractive indexes of the first lens and the second lens and the refractive index of the spacer is less than 0.5.

5. The multilayer lens assembly as defined in claim 1, further comprising an infrared ray filter between the first lens and the spacer.

6. The multilayer lens assembly as defined in claim 1, further comprising an infrared ray filter on the first lens.

7. The multilayer lens assembly as defined in claim 1, further comprising an infrared ray filter between the second lens and the spacer.

8. The multilayer lens assembly as defined in claim 1, further comprising an infrared ray filter on the second lens.

9. The multilayer lens assembly as defined in claim 1, further comprising a support member on a side of the second lens opposite to the spacer, wherein the support member has a bore to expose at least a portion of the second lens.

10. The multilayer lens assembly as defined in claim 1, wherein a thickness of the spacer is greater than 1 μm.

11. A method of making multilayer lens assemblies, comprising the steps of:
A. providing a molten lens material on a base mold and pressing a top mold on the lens material to obtain a first lens layer after the lens material is solidified, and then removing the top mold;
B. providing a molten spacer material on the first lens layer and pressing a top mold on the spacer material to obtain a spacer layer after the spacer material is solidified, and then removing the top mold;
C. providing a molten lens material on the spacer layer and pressing a top mold on the lens material to obtain a second lens layer after the second lens material is solidified, and then removing the top mold;
D. removing the base mold to obtain a lens assembly block; and
E. cutting the lens assembly block to obtain a plurality of multilayer lens assembly.

12. The method as defined in claim 11, further comprising the step of repeating the step B and the step C for predetermined times before the step D.

13. The method as defined in claim 11, wherein the lens materials are photo-curing materials, and the lens materials are respectively exposed under a predetermined light for curing in the step A and the step C.

14. The method as defined in claim 11, wherein the lens materials are UV-curing epoxy, and the lens materials are exposed under UV light for curing in the step A and the step C.

15. The method as defined in claim 13, wherein the top molds used in the step A and the step C are transparent.

16. The method as defined in claim 11, wherein the spacer material is a photo-curing material, and the spacer material is exposed under a predetermined light for curing in the step B.

17. The method as defined in claim 11, wherein the spacer material is UV-curing epoxy, and the spacer material is exposed under UV light for curing in the step B.

18. The method as defined in claim 16, wherein the top mold used in the step B is transparent.

19. The method as defined in claim 11, wherein transmittances of the first lens layer, the second lens layer, and the spacer layer are greater than 95%.

20. The method as defined in claim 11, wherein refractive indexes of the first lens layer, the second lens layer and the spacer layer are greater than 1, and the refractive index of the spacer layer is not identical to the refractive indexes of the first lens layer and the second lens layer.

21. The method as defined in claim 20, wherein a difference between the refractive indexes of the first lens and the second lens and the refractive index of the spacer is less than 0.5.

22. The method as defined in claim 20, wherein the refractive indexes of the first lens, the second lens, and the spacer are in a range between 1.2 and 2.0.

23. The method as defined in claim 11, further comprising the step of providing an infrared ray filter on the first lens layer before the step B.

24. The method as defined in claim 11, further comprising the step of providing an infrared ray filter on the spacer layer before the step C.

25. The method as defined in claim 11, further comprising the step of providing an infrared ray filter on the first lens layer or the second lens layer before the step E.

26. The method as defined in claim 11, further comprising the step of providing a support layer on the second lens layer, and then removing predetermined portions of the support layer before the step D, wherein the remaining portions of the support layer are cut in the step E.

27. The method as defined in claim 11, further comprising the steps of providing a molten mold material on a substrate; pressing a top mold on the mold material for curing; and removing the top mold and the substrate to obtain the base mold before the step A.

28. The method as defined in claim 11, wherein a thickness of the spacer is greater than 1 μm.
